(19) United States
(12) Patent Application Publication
(10) Pub. No.: US 2025/0100622 A1
(43) Pub. Date: Mar. 27, 2025

(54) MODULAR CHASSIS

(71) Applicant: VIVID EV, LLC, Fort Myers, FL (US)

(72) Inventor: Joseph Webster, Fort Myers, FL (US)

(73) Assignee: VIVID EV, LLC, Fort Myers, FL (US)

(21) Appl. No.: 18/807,081

(22) Filed: Aug. 16, 2024

Related U.S. Application Data
(60) Provisional application No. 63/540,754, filed on Sep. 27, 2023.

(51) Int. Cl. B62D 21/12

(52) U.S. Cl. CPC B62D 21/12

(57) ABSTRACT

A vehicle chassis is disclosed that includes a plurality of chassis components, each having one or more associated bolt holes. A first component includes a plurality of redundant bolt holes, each bolt hole associated with a different chassis design. A second component is configured to be bolted to a selected one of the plurality of redundant bolt holes.

### RELATED APPLICATIONS

This application claims benefit of and priority to U.S. provisional patent application No. 63/540, 754, filed Sep. 27, 2023, which his hereby incorporated by reference for all purposes as if set forth herein in its entirety.

### TECHNICAL FIELD

The present disclosure relates generally to vehicles, and more specifically to a modular chassis for a vehicle that can be assembled by bolting together a plurality of components.

### BACKGROUND OF THE INVENTION

The manufacture of a vehicle chassis requires most components to be welded together, and prevents the components from being interchangeable between different chassis configurations.

### SUMMARY OF THE INVENTION

A vehicle chassis is disclosed that includes a plurality of chassis components, each having one or more associated bolt holes. A first component includes a plurality of redundant bolt holes, each bolt hole associated with a different chassis design. A second component is configured to be bolted to a selected one of the plurality of redundant bolt holes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a modular chassis, in accordance with an example embodiment of the present disclosure;

FIG. 2 is a diagram of an assembled frame, in accordance with an example embodiment of the present disclosure;

FIG. 3 is a diagram of side view showing a detail of the assembly of a leaf spring, rear shackle and shackle support, in accordance with an example embodiment of the present disclosure;

FIG. 4 is a detail of an upper control arm in accordance with an example embodiment of the present disclosure;

FIG. 5 is a detail of a control arm bracket showing a bolt hole and an adjustable support;

FIG. 6 is a detail of a shock tower showing a bolt hole that can be used to connect the shock tower to a base and other suitable components;

FIG. 7 is a detail of a rear shackle and shackle support with bolt holes and an adjustable support, which is used to hold a pin that couples to penetrations of the rear shackle; and

FIG. 8 is a diagram of a system for assembling a chassis, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present disclosure relate to a modular chassis, suspension and underbody for a vehicle, such as a golf cart, a personal transportation vehicle, a neighborhood electric vehicle, a utility vehicle or other suitable low-speed vehicles. These vehicle components are usually fabricated from a large number of welded components, which requires different components to be developed to accommodate different vehicle configurations. The use of welding to assemble these components also requires separate lift kits to modify the ride height of the vehicle. Repairs can also be more costly, because a damaged component might be part of a welded system and may require skilled labor to remove and reinstall and/or replace components, simply due to their being part of the welded system. The present disclosure provides a solution to these problems, which have been present but unrecognized.

Because of the need to stock entire assembled chassis, suspensions and underbodies, as well as major assemblies of those components for repair, dealers require more space and resources for inventory to ensure they have every type of vehicle to meet each customer's preference. This is very costly and dramatically reduces inventory turns. Not carrying an appropriate amount of options in a dealer's inventory could cause them to lose sales, and it can be difficult to determine how much inventory is enough.

In addition, vehicles of these types do not incorporate caster adjustment settings in their designs, making it impossible to perform a full front wheel alignment. While some designs allow toe and camber to be adjusted, no current configurations allow caster to be adjusted.

The modularity of the disclosed embodiments allows for a single system to be built with multiple seating arrangements, multiple wheel base lengths and different suspension configurations without separate frames or lift kits. The present disclosure also permits parts of the chassis to be replaced individually, because no welds are needed. Adjustments to the ride height and suspension setting can be readily implemented. The front suspension and steering geometry provide for full adjustability to perform full front wheel alignment, including toe, camber, and caster alignment.

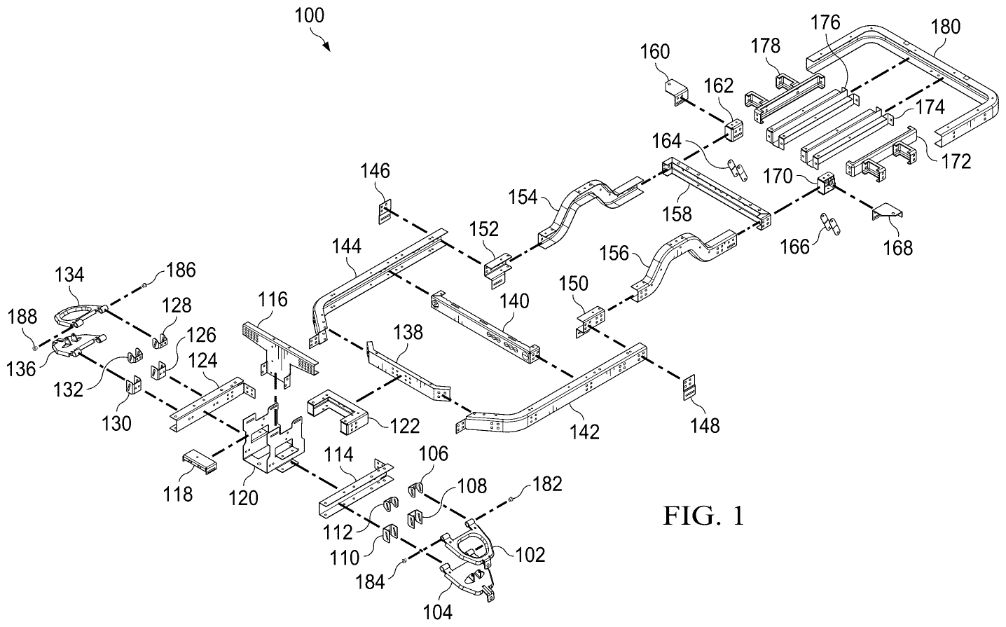

FIG. 1 is a diagram of a modular chassis 100, in accordance with an example embodiment of the present disclosure. The modular components can be fabricated from aluminum alloys, stainless steel, titanium alloys, magnesium alloys or other suitable materials, and include bolt holes as shown for assembly using bolts instead of welding. Likewise, disassembly can be readily performed to replace damaged components or for other suitable purposes.

Modular chassis 100 allows components to be assembled for different vehicle designs on demand, to eliminate the need to stock assembled chassis and the associated space and materials requirements. Modular chassis 100 includes upper control arm 102 and lower control arm 104, which can be fabricated from aluminum alloys, stainless steel, titanium alloys, magnesium alloys or other suitable materials. In general, all components of modular chassis 100 are fabricated from the same material, although selected components can be fabricated from materials that have greater strength, flexibility or other suitable characteristics, depending on the design requirements.

Upper control arm 102 and lower control arm 104 are configured to be coupled to support 114 and base 120 by control arm brackets 106, 108, 110 and 112, which can be bolted together by suitable bolt fasteners placed in the bolt holes, as shown. The bolt fasteners for these and other connections disclosed herein can be hex bolts, spade bolts, square bolts, carriage bolts, T-type bolts, U-type bolts, eye bolts, cap screws, machine screws, panel screws, sheet metal screws, shoulder screws, set screws or other suitable connectors, with coarse (UNC) threads, fine (UNF) threads, cold rolled threads, machined threads, self-threading fasteners or other suitable threads. Control arm brackets 106, 108, 110 and 112 and shock tower 116 allow for suspension ride height adjustments. The angled adjustment allows track width to be maintained while adjusting height. The upper control arm 102 and lower control arm 104 each accept a Heim joint to allow for camber adjustment. Thrust bearings 182 and 184 are coupled to upper control arm 102, and thrust bearings 186 and 188 are coupled to upper control arm 134, and thrust bearings can be used for other suitable connections, such as for lower control arms 104 and 136. Base 120 includes “serrated” slot borders that allow a pin, bolt or other suitable connectors to be placed in one of a number of selectable positions, so as to allow for caster adjustments, and thrust bearings to allow for minor caster adjustment.

Shock tower 116 and support 118 are coupled to base 120 through the bolt holes as shown using the connectors discussed above or other suitable connectors. Support 122 connects supports 114 and 124 to support 138 through the bolt holes as shown using the connectors discussed above or other suitable connectors. Upper control arm 134 and lower control arm 136 are coupled to support 114 and base 120 by control arm brackets 126, 128, 130 and 132 through the bolt holes as shown using the connectors discussed above or other suitable connectors. Control arm brackets 126, 128, 130 and 132 and shock tower 116 allow for suspension ride height adjustments.

Support 140 is coupled to frames 142 and 144 through the bolt holes as shown using the connectors discussed above or other suitable connectors. Leaf spring mount 146 and leaf spring mount 148 are coupled to frames 144 and 142 and brackets 152 and 150, respectively, through the bolt holes as shown using the connectors discussed above or other suitable connectors. Frames 154 and 156 are coupled to brackets 152 and 150, respectively, and support 158, through the bolt holes as shown using the connectors discussed above or other suitable connectors. Support 158 is coupled to shackle supports 162 and 170 and rear shackles 164 and 166, respectively, through the bolt holes as shown using the connectors discussed above or other suitable connectors. Adjustable rear shackles 164 and 166 allow for rear suspension height adjustment using leaf spring mount 146 and leaf spring mount 148 with various length and camber.

Brackets 160 and 168 are coupled to shackle supports 162 and 170, respectively, through the bolt holes as shown using the connectors discussed above or other suitable connectors. Frame 180 is couple to frames 172 and 178 and supports 174 and 176, through the bolt holes as shown using the connectors discussed above or other suitable connectors.

In operation, modular chassis 100 can be assembled from the components shown using bolts or other suitable connectors, and can be disassembled as needed for repair, upgrades or other suitable reasons. While a number of example components and configurations are shown, a person of skill in the art will recognize that each specific component can be modified or omitted where suitable, and that additional components can also or alternatively be used. Likewise, the present disclosure can be used with assemblies other than a chassis, such as suspensions, underbodies and so forth.

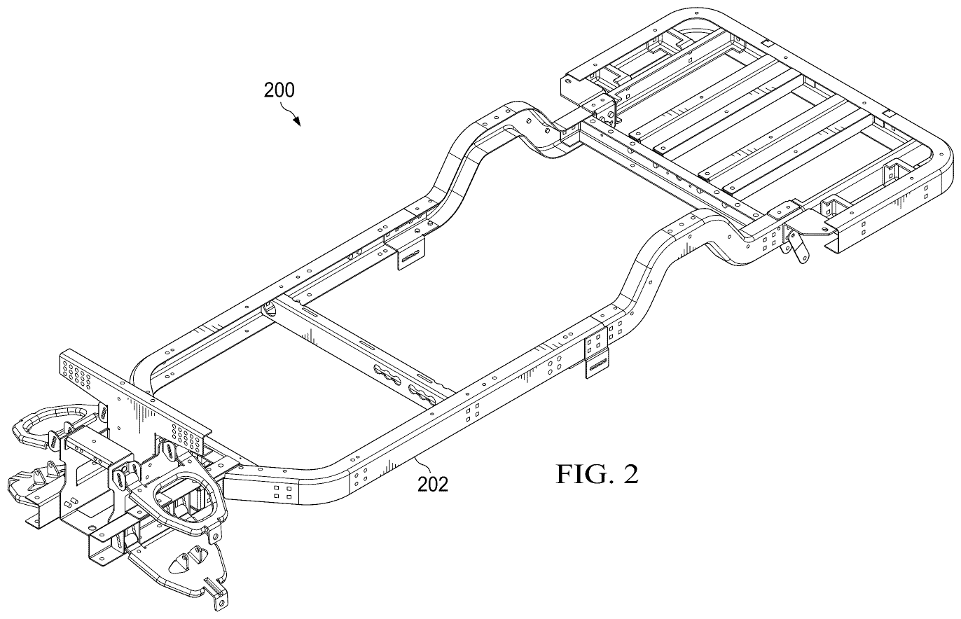

FIG. 2 is a diagram 200 of assembled frame 202, in accordance with an example embodiment of the present disclosure. Diagram 200 provides additional details in graphical form on how the components discussed in regards to FIG. 1 can be assembled using the teachings of the present disclosure. While not necessarily to scale, the relative sizes and orientations are accurate, such that a component that is shown connected on top of or at a right angle to another component would be correctly oriented, and a component that appears to be twice as large as another component would be correctly interpreted as being generally larger.

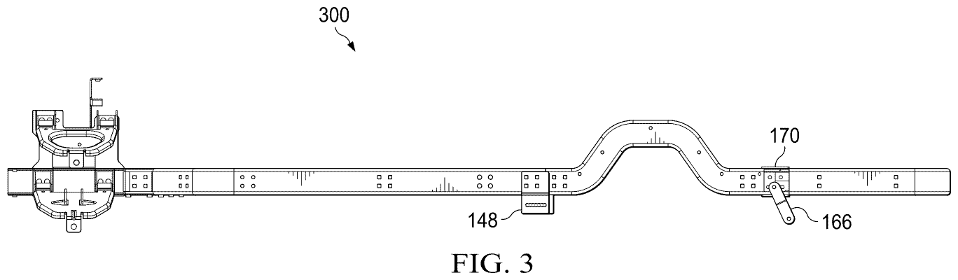

FIG. 3 is a diagram of side view 300, showing a detail of the assembly of leaf spring mount 148, rear shackle 166 and shackle support 170, in accordance with an example embodiment of the present disclosure. Side view 300 demonstrates how the structure assembly with “serrated” slot borders can be used to allow for caster adjustments. In addition, adjustable rear shackles allow for rear suspension height adjustment using leaf spring mounts that can accommodate various lengths and cambers, such as by using a one of a plurality of penetrations in the “serrated” slot borders of leaf spring mount 148 to connect to a leaf spring, so as to select an adjustable location for the leaf spring.

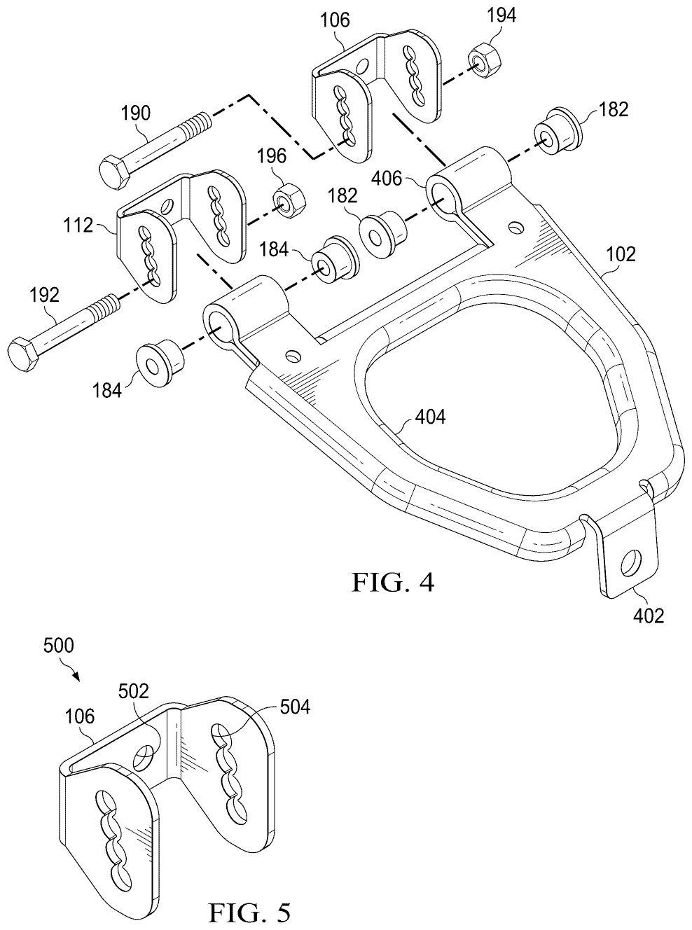

FIG. 4 is a detail of upper control arm 102 in accordance with an example embodiment of the present disclosure. The other control arms such as lower control arm 104, upper control arm 134 and lower control arm 136 are substantially similar to upper control arm 102, except as otherwise noted.

Upper control arm 102 includes support 402, which includes a hole that is configured to accept a Heim joint (not explicitly shown) to allow for camber adjustment. Upper control arm 102 also includes passage 404 for receiving a coil spring or other suitable suspension system component. Lower control arm 104 contains a support for the coil spring or other suitable suspension system component, as opposed to passage 404, as shown in FIGS. 1 and 2. Barrel 406 is used to hold a pin to allow upper control arm 102 to be adjusted. Thrust bearings 182 and 184 couple to barrel 406, and pins 190 and 192 are used with nuts 194 and 196, respectively, to secure barrel 406 to control arm bracket 106 and control arm bracket 112, which include “serrated” slots with a number of user-selectable positions that can be used to customize the modular chassis 100. The angled adjustment allows track width to be maintained while adjusting height.

FIG. 5 is a detail 500 of control arm bracket 106 showing bolt hole 502 and adjustable support 504. The pin used in conjunction with barrel 406 can be placed in one of the pair of penetrations in the “serrated” slots of adjustable support 504 to allow the control arm to be configured for the specific chassis design that it is being installed on.

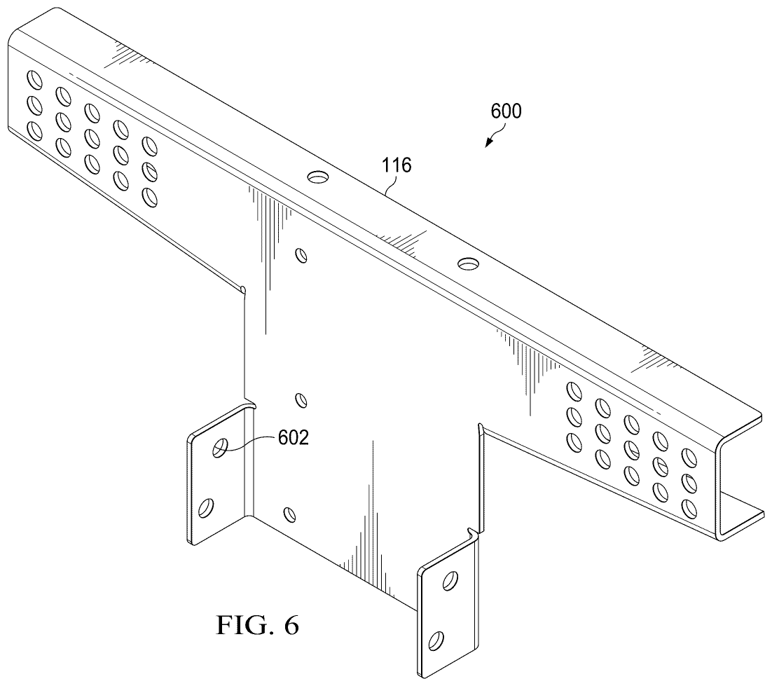

FIG. 6 is a detail 600 of shock tower 116 showing bolt hole 602, which can be used to connect shock tower 116 to base 120 and other suitable components. The disclosed embodiments allow shock tower 116 to be modified or replaced without cutting metal or welding, and also allows the chassis to be fabricated on demand to match a selected model and without the need for welding or cutting metal.

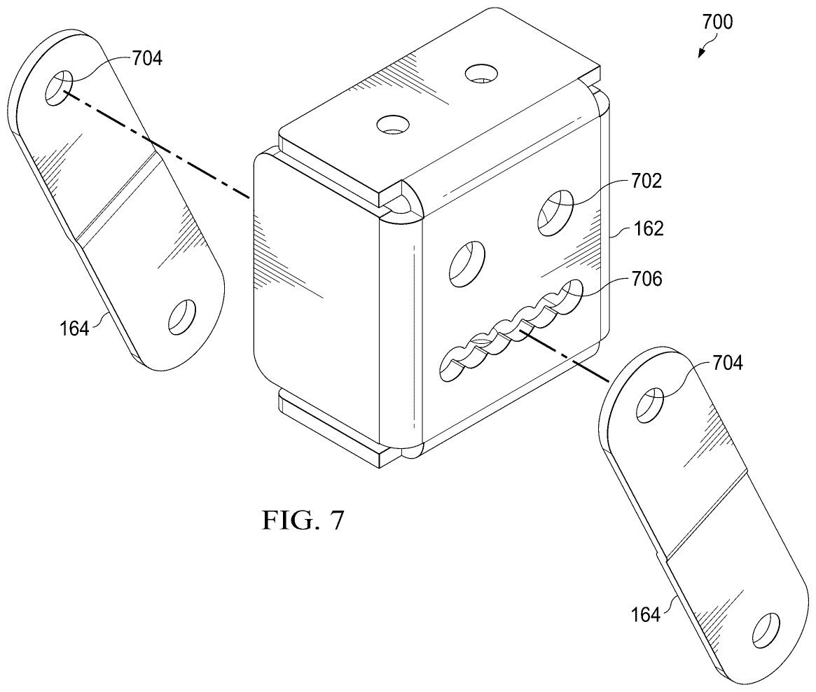

FIG. 7 is a detail 700 of rear shackle 164 (similar to rear shackle 166) and shackle support 162 (similar to shackle support 170), showing bolt holes 702 and adjustable support 706, which is used to hold a pin that couples to penetrations 704 of rear shackle 164. The disclosed embodiments allow rear shackle 164 to be modified or replaced without cutting metal or welding, and also allows rear shackle 164 to be placed in adjustable support 706 to match a selected model and chassis without the need for welding or cutting metal. Likewise, bolt holes 702 allow shackle support 162 to be modified or replaced without cutting metal or welding, and also allow shackle support 162 to be matched to a selected model and chassis without the need for welding or cutting metal.

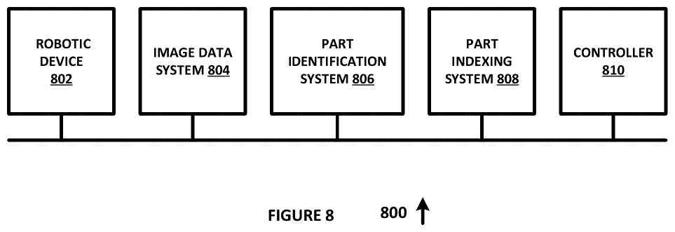

FIG. 8 is a diagram of a system 800 for assembling a chassis, in accordance with an example embodiment of the present disclosure. System 800 includes robotic device 802, image data system 804, part identification system 806, part indexing system 808 and controller 810, each of which can be implemented in hardware or a suitable combination of hardware and software.

Robotic device 802 can be implemented as one or more programmable controllers that control one or more electromechanical devices such as stepper motors, manipulators, effectors, feedback devices, actuators or other suitable components. The programmable controllers of robotic device 802 can be configured to receive operating instructions from controller 810 that cause robotic device 802 to pick up a part, to move the part to a specific location, to manipulate the part and to perform other suitable functions. In one example embodiment, manipulation of the part can include inserting a bolt or other connector into a predetermined bolt hole after the part has been properly aligned, wherein the alignment requires discrimination between closely placed bolt holes, and then securing the bolt in position by applying a predetermined amount of torque to a nut or other component.

Image data system 804 can be implemented as one or more programmable controllers that control one or more image data capture devices that generate digital image data. In one example embodiment, image data system 804 can include a number of movable image data capture devices that are used to examine a part from different angles, to be relocated, to generate image data during movement and to perform other suitable functions.

Part identification system 806 can be implemented as one or more programmable controllers that receive image data from image data system 804 and generate control data as a function of design data associated with an identified part. In one example embodiment, a plurality of components can be assembled on demand to form a vehicle chassis, and part identification system 806 can be used to identify components that are selected or that are connected to selected components, to identify components that have already been assembled to identify the correct component for a new component to be connected to, or to perform other suitable functions. Components can include multiple alternate connection points, and part identification system 806 can be used to determine the proper connection for a specific chassis design that is being assembled.

Part indexing system 808 can be implemented as one or more programmable controllers that control one or more part retrieval systems or other suitable systems to obtain parts on demand for fabrication of a chassis. In one example embodiment, part indexing system 808 can provide data to robotic device 802, image data system 804, part identification system 806 and other suitable systems to coordinate with part retrieval, confirming that the correct part has been obtained and installation/assembly of the part onto the chassis.

Controller 810 can be implemented as one or more algorithms that are loaded into a data memory of a processor that cause the processor to control the chassis assembly process and other components of system 800. In one example embodiment, controller 810 can update data on each of robotic device 802, image data system 804, part identification system 806 and part indexing system 808, such as to modify the position of robotic device 802 to obtain image data from robotic device 802 image data system 804 that is required by part identification system 806, to return a part that was improperly stored to a correct storage location using part indexing system 808 and to perform other suitable functions.

An automated assembly system can also or alternatively be used to assemble the modular chassis. In this example embodiment, components can be selected from storage using machine vision or other suitable processes and brought to an assembly area. A component placement system can use cameras or other suitable sensors to determine the orientation of two components and to use a first robotic system to manipulate and move the components into position. A second robotic system can then be used to connect a bolt to a nut or to assemble other suitable connectors. An inspection system can then be used to verify that the components have been properly assembled, such as by comparing image data of the components to design data. A repair system can also be used to identify damaged components and to replace the damaged components.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A vehicle chassis, comprising:
a plurality of chassis components, each having one or more associated bolt holes;
wherein a first component comprises a plurality of redundant bolt holes, each bolt hole associated with a different chassis design;
wherein a second component is configured to be bolted to a selected one of the plurality of redundant bolt holes.

2. The vehicle chassis of claim 1 further comprising a control arm coupled to a Heim joint.

3. The vehicle chassis of claim 1 wherein the first component comprises a support and the second component comprises a control arm bracket.

4. The vehicle chassis of claim 1 wherein the first component comprises a support and the second component comprises a control arm bracket having a plurality of adjustable support holes configured to receive a pin.

5. The vehicle chassis of claim 1 wherein the first component comprises a control arm bracket having a plurality of adjustable support holes and the second component comprises a control arm bracket configured to receive a pin, and further comprising the control arm coupled to the control arm bracket by the pin.

6. The vehicle chassis of claim 1 wherein the first component comprises a leaf spring mount and the second component comprises a frame component.

7. The vehicle chassis of claim 1 wherein the plurality of redundant bolt holes form a serrated slot.

8. The vehicle chassis of claim 1 wherein the first component comprises a support and the second component comprises a control arm bracket having a plurality of support holes, each configured to receive a thrust bearing.

9. The vehicle chassis of claim 1 wherein the first component and the second component and manipulated by a robotic device and a bolt is secured in the selected one of the plurality of redundant bolt holes by the robotic device.

10. A vehicle chassis, comprising:
a plurality of chassis components, each having two or more associated connectors, each connector associated with a different chassis configuration;
wherein a first component comprises a plurality of redundant connectors, each connector associated with a different chassis design;
wherein a second component is configured to be coupled to a selected one of the plurality of redundant connectors.

11. The vehicle chassis of claim 10 further comprising a control arm coupled to a Heim joint.

12. The vehicle chassis of claim 10 wherein the first component comprises a support and the second component comprises a control arm bracket.

13. The vehicle chassis of claim 10 wherein the first component comprises a support and the second component comprises a control arm bracket having a plurality of adjustable support holes configured to receive a pin.

14. The vehicle chassis of claim 10 wherein the first component comprises a control arm bracket having a plurality of adjustable support holes and the second component comprises a control arm bracket configured to receive a pin, and further comprising the control arm coupled to the control arm bracket by the pin.

15. The vehicle chassis of claim 10 wherein the first component comprises a leaf spring mount and the second component comprises a frame component.

16. The vehicle chassis of claim 10 wherein the plurality of redundant connectors form a serrated slot.

17. The vehicle chassis of claim 10 wherein the first component comprises a support and the second component comprises a control arm bracket having a plurality of support holes, each configured to receive a thrust bearing.

18. The vehicle chassis of claim 10 wherein the first component and the second component are configured to be manipulated by a robotic device and a connector device is secured in the selected one of the plurality of connectors by the robotic device.
